(19) United States
(12) Patent Application Publication
(10) Pub. No.: US 2003/0138052 A1
(43) Pub. Date: Jul. 24, 2003

(54) Video coding and decoding method, and corresponding signal

(76) Inventors: Cecile Dufour, Paris (FR); Gwenaelle Marquant, Paris (FR); Stephane Edouard Valente, Paris (FR)

Correspondence Address: Michael E. Marion, c/o U.S. PHILIPS CORPORATION, Intellectual Property Department, 580 White Plains Road, Tarrytown, NY, 10591, US

(21) Appl. No.: 10/242,929

(22) Filed: Sep. 13, 2002

(30) Foreign Application Priority Data
Sep. 18, 2001 (EP) 01402391.5

(51) Int. Cl. H04N 7/12

(52) U.S. Cl. 375/240.27

(57) ABSTRACT

The invention relates to a video coding method applied to a sequence of frames and generating a coded bitstream in which each data item is described by means of a bitstream syntax allowing any decoder to recognize and decode all the segments of the content of said bitstream. According to the invention, which finds an application for instance within the video compression standards of the MPEG and ITU-H.26X families, the syntax comprises a flag provided for indicating at a high description level, for each channel described in the coded bitstream, the presence, or not, of an encoded residual signal, said residual being defined by means of a prediction technique, applied to previously decoded frames and followed by the construction of said residual signal.

The present invention generally relates to the field of video compression and, for instance, more specifically to the video standards of the MPEG family (MPEG-1, MPEG-2, MPEG-4) and of the ITU-H.26X family (H.261, H.263 and extensions, H.26L). This invention concerns a video coding method applied to a sequence of video frames and generating a coded bitstream in which each data item is described by means of a bitstream syntax allowing any decoder to recognize and decode all the segments of the content of said bitstream.

The invention also relates to a device for carrying out said coding method, to a transmittable video signal delivered by such a coding device, to a video decoding method for decoding said transmittable signal, and to a corresponding decoding device.

In the first video standards (up to MPEG-4 and H.26L), the video is predictively encoded on a macroblock basis along different separate channels (for example luminance, chrominance, shape, . . . ). This prediction is performed using a motion compensation technique as described for instance in the document “MPEG video coding: a basic tutorial introduction”, S. R. Ely, BBC Research and Development Report, 1996. A motion vector field is applied to previously decoded frames to form a prediction of the current frame to be encoded. A difference image, called the residual signal, or simply the residual, is then obtained by subtraction of the current frame to be encoded and this prediction frame.

This residual, present along all the channels present in the input signal (luminance, chrominance, shape, . . . ) is then binaryly encoded. However, there are situations where the residual contains very few information, for instance when the energy of this residual is very low owing to the redundancy between two consecutive frames, or when the bit budget does not allow to encode much information about texture. With the above-cited standards, the syntaxes describing the signals to be transmitted always include a description of the fact that no information is encoded and force the transmission of these descriptive elements, which are not necessary. The consequence of this lack of flexibility is a waste of bits and therefore a loss of coding efficiency, illustrated for example in the case of the standards MPEG-4 and H.26L (and while assuming, for instance, that it is not desired to send the residual signal for the luminance and chrominance channels of a given picture):

a) standard MPEG-4:

As defined in pages 50 and 53 of the MPEG-4 document number w3056, also referenced “Information Technology—Coding of audio-visual objects—Part 2: Visual”, ISO/IEC JTC1/SC29/WG11, Maui, USA, December 1999, a field called “cbpy” is used as a descriptive element telling which 8×8 luminance blocks have been actually encoded in the bitstream for a particular macroblock (MB) of 16×16 picture elements (pixels), said descriptive element being entropy-encoded by variable length codes (VLCs) found in table B-8, p.340 of the same document (when no residual signal is encoded for the four blocks of the macroblock, this element is “0 0 0 0”, encoded on 2 bits). Similarly, a field called “mcbpc” (see same pages 50 and 53) is used as a descriptive element for indicating which 8×8 chrominance blocks (U and V) have been encoded for the macroblock (when no residual signal is present, “mcbpc” takes the values “0 0”). Several VLC tables are used, depending on the macroblock type, and the “0 0” value is therefore represented by 1 to 6 bits in the bitstream (see tables B-6 and B-7, p.339). As a result, the information “no residual signal is encoded” needs between 3 and 8 bits by macroblock, and, for example, the waste of bits consequently ranges from 396×3 bits/macroblock (=1188 bits) to 396×8 bits/macroblock (=3168 bits) for a CIF (Common Intermediate Format) inter picture (of size 352×288 pixels) including 396 macroblocks.

b) standard H.26L:

As defined in page 16 of the H.26L document Q15-K-59 “H.26L Test Model Long Term Number 5 (TML-5)-Draft 0”, ITU-Telecommunications Standardization Sector, 11^{th} Meeting, Portland, Oreg., USA, Aug. 22-25, 2000, a so-called Coded Block Pattern (CBP) syntax element is used at the macroblock level to indicate the fact that no residual signal is present. This element, in which said information is encoded, more precisely contains two kinds of information for a given 16×16 macroblock: which 8×8 luminance blocks have been encoded in the bitstream (on 4 bits), and whether or not chrominance coefficients have been encoded (3 possibilities coded on 2 bits). The CBP element for “no residual signal” takes the decimal value “0”, which is encoded on 1 bit (according to the same document, table 1, p.7), and the waste of bits is therefore 396 bits (exactly) for a CIF inter picture.

It is therefore an object of the invention to propose a video coding method allowing to reduce such a waste of bits and therefore to improve the coding efficiency.

To this end, the invention relates to a method such as defined in the introductory part of the description and which is moreover characterized in that said syntax comprises a flag indicating at a high description level, for each channel described in the coded bitstream, the presence, or not, of an encoded residual signal, and to a corresponding coding device.

The invention also relates to a transmittable video signal consisting of a coded bitstream generated by such a video coding method and in which each data item is described by means of a bitstream syntax allowing any decoder to recognize and decode all the segments of the content of said bitstream, said video frames being, on a macroblock basis, encoded by means of a prediction technique provided for generating a prediction of the current frame and followed by a subtraction of the current frame to be encoded and this prediction frame, said subtraction leading to a difference image called residual and constituting the signal to be encoded, said signal being characterized in that it includes a syntactic element provided for indicating at a high description level, for each channel described in the coded bitstream, the presence, or not, of an encoded residual signal.

The invention also relates to a video decoding method for decoding said transmittable video signal, and to a corresponding decoding device.

The invention will now be described in a more detailed manner, with reference to the accompanying drawing in which:

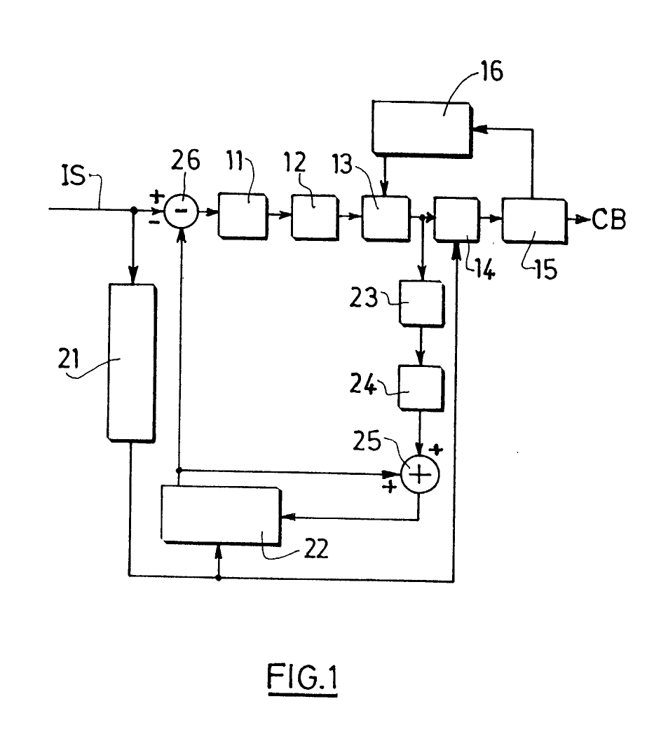

FIG. 1 shows an example of an MPEG coder with motion compensated interframe prediction.

To solve the problem of waste of bits explained above, it is proposed to introduce, whatever the type of standard considered, an additional syntactic element allowing to introduce more flexibility in these standards. This introduction is implemented by means of the addition, in the bitstream, at a high description level, equivalent for instance to the Video Object Layer (VOL) MPEG-4 level, of specific flags intended, according to the invention, to provide in the bitstream an indication on whether or not the residual signal is encoded. As said indication can be different among various channels, it is in fact proposed to define such information at a higher level than at the macroblock level, for each of these channels (luminance, chrominance, shape, . . . ), which will moreover offer a great flexibility for future standards.

In the following description, it is assumed that the presence of channels is described by several syntax elements at the sequence level (VOL in MPEG-4 terminology), these elements being for instance:

| | |
|---|---|
| Video_object_layer_lum | 1 bit |
| Video_object_layer_chrom | 1 bit (0 for black and white) |
| Video_object_layer_additional_channels_enable | 1 bit (0 for only luminance and |
| | chrominance channels) |
| Number_of_additional_channels | 4 bits |
| Video_object_additional_channels[i] | 1 bit (0 for no presence) |
| Examples of additional channels may be: | |
| Video_object_layer_shape | 1 bit (0 for rectangular) |
| Video_object_layer_depth | 1 bit (0 for flat depth,) |

These syntax elements should be read as follows:

if “Video_object_layer_lum” is 1, it means that the bitstream contains syntax elements for a luminance channel;

if “Video_object_layer_chrom” is 1, the bitstream contains syntax elements for the chrominance channels, else the sequence is assumed to be black and white;

if “Video_object_layer_additional_channels_enable” is 1, the bitstream contains syntax elements describing additional channels.

In such a case, the variable “Number_additional_channels” holds the number of additional channels. In case additional channels are present in addition to the luminance and chrominance channels, the following syntax can be found:

if “Video_object_layer_shape” is 1, the bitstream contains syntax elements intented to describe a non-rectangular shape for the picture, else it is assumed to be rectangular;

if “Video_object_layer_depth” is 1, the bitstream contains syntax elements intended to describe the depth texture for the picture, else it is assumed to be a flat picture;

other channels description can be found depending on the number of additional channels (Number_of_additional_channels).

In order to indicate the residual signal presence for the related channels, the following flags are proposed (i designating the i-th additional channel):

| Syntax: | Size |
|---|---|
| Vop_lum_channel_coded | 1 bit |
| Vop_chrom_channel_coded | 1 bit |
| Vop_additional_channel_coded[i] | 1 bit |

This syntax elements should be retrieved from the bitstream before decoding every inter picture only if the presence of the corresponding channel was indicated at a higher level. This corresponds for instance to the following algorithm written here in pseudo C-code, where the function read_bit (1) returns the next unread bit from the bitstream:

/* set the default value of the flags */

Vop_lum_channel_coded = 0 ;
Vop_chrom_channel_coded = 0 ;
For (i = 0, with i<number_of_additional_channels ; i++)

Vop_additional_channel_coded[i] = 0 ;

/* read the flags from the bitstream */
If (Video_object_layer_lum)

{

Vop-lum_channel_coded = read_bit (1) ;

If ((Video_object_layer_chrom)

Vop_chrom_channel_coded = read_bit (1) ;

}

If (Video_object_layer_additional_channels_enable)

{

For (i=0, with i<number_of_additional_channels ; I++)

Vop_additional_channel_coded[i] = read bit(1) ;

}

Concerning the semantic meaning of these elements, the proposed 1 bit syntax should be understood as follows:

Vop_lum_channel_coded: if set to one, it indicates that some residual signal was coded for the luminance channel of the current picture, while it indicates that no luminance residual signal was coded for this picture if set to 0.

Vop_chrom_channel_coded: if set to one, it indicates that some residual signal was coded for the chrominance channel of the current picture, while it indicates that no chrominance residual signal was coded for this picture if set to 0.

Vop_additional_channel_coded [i]: if set to one, it indicates that some residual signal was coded for the i^{th} additional channel, while it indicates that no residual signal was coded for said i^{th} additional channel if set to 0.

The video coding method described above may be implemented in a coding device such as for instance the one illustrated in FIG. 1 showing an example of an MPEG coder with motion compensated interframe prediction, said coder comprising coding and prediction stages. The coding stage itself comprises a mode decision circuit 11 (for determining the selection of a coding mode I, P or B as defined in MPEG), a DCT circuit 12, a quantization circuit 13, a variable-length coding circuit 14, a buffer 15 and a rate control circuit 16. The prediction stage comprises a motion estimation circuit 21, a motion compensation circuit 22, an inverse quantization circuit 23, an inverse DCT circuit 24, an adder 25, and a subtractor 26 for sending towards the coding stage the difference between the input signal IS of the coding device and the predicted signal available at the output of the prediction stage (i.e. at the output of the motion compensation circuit 22). This difference, or residual, is the bitstream that is coded, and the output signal CB of the buffer 15 is the coded bitstream that, according to the invention, will include the syntactic element indicating at a high description level, for each channel described in the coded bitstream, the presence, or not, of an encoded residual signal.

Another example of coding device may be based on the specifications of the MPEG-4 standard. In the MPEG-4 video framework, each scene, which may consist of one or several video objects (and possibly their enhancement layers), is structured as a composition of these objects, called Video Objects (VOs) and coded using separate elementary bitstreams. The input video information is therefore first split into Video Objects by means of a segmentation circuit, and these VOs are sent to a basic coding structure that involves shape coding, motion coding and texture coding. Each VO is, in view of these coding steps, divided into macroblocks, that consist for example in four luminance blocks and two chrominance blocks for the format 4:2:0 for example, and are encoded one by one. According to the invention, the multiplexed bitstream including the coded signals resulting from said coding steps will include the syntactic element indicating at a high description level, for each channel described in the coded bitstream, the presence, or not, of an encoded residual signal.

Reciprocally, according to a corresponding decoding method, this syntactic element, transmitted to the decoding side, is read by appropriate means in a video decoder receiving the coded bitstream that includes said element and carrying out said decoding method. The decoder, which is able to recognize and decode all the segments of the content of the coded bitstream, reads said additional syntactic element and knows that no encoded residual signal is then present. Such a decoder may be of any MPEG-type, as the encoding device, and its essential elements are for instance, in series, an input buffer receiving the coded bitstream, a VLC decoder, an inverse quantizing circuit and an inverse DCT circuit. Both in the coding and decoding device, a controller may be provided for managing the steps of the coding or decoding operations.

The foregoing description of the preferred embodiments of the invention has been presented for purposes of illustration and description. It is not intended to be exhaustive or to limit the invention to the precise forms disclosed, and obviously modifications and variations, apparent to a person skilled in the art and intended to be included within the scope of this invention, are possible in light of the above teachings.

It may for example be understood that the coding and decoding devices described herein can be implemented in hardware, software, or a combination of hardware and software, without excluding that a single item of hardware or software can carry out several functions or that an assembly of items of hardware and software or both carry out a single function. The described methods and devices may be implemented by any type of computer system or other adapted apparatus. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized.

The present invention can also be embedded in a computer program product, which comprises all the features enabling the implementation of the methods and functions described herein and—when loaded in a computer system—is able to carry out these methods and functions. Computer program, software program, program, program product, or software, in the present context mean any expression, in any language, code or notation, of a set of instructions intended to cause having information processing capability to perform a particular function either or both of the following: (a) conversation to another language, code or notation; and/or (b) reproduction in a different material form.

1. A video coding method applied to a sequence of video frames and generating a coded bitstream in which each data item is described by means of a bitstream syntax allowing any decoder to recognize and decode all the segments of the content of said bitstream, said video frames being, on a macroblock basis, encoded by means of a prediction technique provided for generating a prediction of the current frame and followed by a subtraction of the current frame to be encoded and this prediction frame, said subtraction leading to a difference image called residual and constituting the signal to be encoded, said method being further characterized in that said syntax includes a flag indicating at a high description level, for each channel described in the coded bitstream, the presence, or not, of an encoded residual signal.

2. A video coding method according to claim 1, in which said video frames are predictively encoded by means of a motion compensation technique.

3. A video coding method according to claim 1, in which said video frames are predictively encoded by means of an upsampling operation of a lower resolution base signal.

4. A transmittable video signal consisting of a coded bitstream generated by a video coding method according to anyone of claims 1 to 3 and in which each data item is described by means of a bitstream syntax allowing any decoder to recognize and decode all the segments of the content of said bitstream, said video frames being, on a macroblock basis, encoded by means of a prediction technique provided for generating a prediction of the current frame and followed by a subtraction of the current frame to be encoded and this prediction frame, said subtraction leading to a difference image called residual and constituting the signal to be encoded, said signal being characterized in that it includes a syntactic element provided for indicating at a high description level, for each channel described in the coded bitstream, the presence, or not, of an encoded residual signal.

5. A video decoding method provided for decoding a transmittable video signal consisting of a coded bitstream generated by implementation of a video coding method applied to a sequence of video frames and generating said coded bitstream in which each data item is described by means of a bitstream syntax allowing any decoder to recognize and decode all the segments of the content of said bitstream, said video frames being, on a macroblock basis, encoded by means of a prediction technique provided for generating a prediction of the current frame and followed by a subtraction of the current frame to be encoded and this prediction frame, said subtraction leading to a difference image called residual and constituting the signal to be encoded, said signal being characterized in that it includes a syntactic element provided for indicating at a high description level, for each channel described in the coded bitstream, the presence, or not, of an encoded residual signal.

6. A video decoding device for decoding a transmittable video signal consisting of a coded bitstream generated by implementation of a video coding method applied to a sequence of video frames and generating said coded bitstream in which each data item is described by means of a bitstream syntax allowing any decoder to recognize and decode all the segments of the content of said bitstream, said video frames being, on a macroblock basis, encoded by means of a prediction technique provided for generating a prediction of the current frame and followed by a subtraction of the current frame to be encoded and this prediction frame, said subtraction leading to a difference image called residual and constituting the signal to be encoded, said signal comprising a syntactic element provided for indicating at a high description level, for each channel described in the coded bitstream, the presence, or not, of an encoded residual signal.
